(19) United States
(12) Patent Application Publication
(10) Pub. No.: US 2006/0248472 A1
(43) Pub. Date: Nov. 2, 2006

(54) Clip history

(76) Inventors: Martin Helie, Laval (CA); Stephen F. White, Laval (CA)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 11/107,435

(22) Filed: Apr. 15, 2005

(51) Int. Cl. G06F 17/00; G06F 3/00; G06F 9/00

(52) U.S. Cl. 715/810

(57) ABSTRACT

A method, apparatus, system, and article of manufacture provide the ability to modify a clip. Initially, a first processed result clip having a clip history is obtained. The clip history comprises an operation performed to produce the first result clip. The first result clip is loaded into a processing application (e.g., a module, process tree, or timeline). The operation (in the clip history) is modified using the processing application. Once modified, a second result clip is produced based on the modified operation.

### BACKGROUND OF THE INVENTION

1. Field of the Invention

The present invention relates generally to image/video display and processing systems, and in particular, to a method, apparatus, and article of manufacture for viewing and working with clips and a clip history.

2. Description of the Related Art

A clip is a sequence of images or frames loaded from an external device such as a VTR (video tape recorder), stored in digital format, and displayed in a clip library and on a desktop. Clips may be edited, processed, and recorded to/on external devices. However, once a clip has been created, prior art solutions do not provide the ability to modify the operations used during the creation of the clip. Instead, the prior art requires the user to discard the entire sequence of operations and attempt to reproduce and guess the sequence of operations performed starting with an original source clip. Accordingly, the prior art fails to provide a useful and efficient mechanism for changing a single clip creation operation subsequent to clip creation. The disadvantages of the prior art may be better understood by describing prior art clips and clip processing.

Operators, tasks, or modules/functions may perform a variety of functions with respect to a clip or source. For example, a module may perform compositing, painting, color correction, degraining, blurring, etc

FIG. 1 illustrates a process tree in a schematic view. A schematic view 100 uses node(s) 102-104 to represent all of the operators in a workspace performed on one or more clips 106-110, and line(s) (edges) 112-118 between nodes clips 106-110 and nodes 102-104 to indicate the flow of image data between the operators. The output of one node 102 is the source for the next node 104. As a result clip 104 or other branch (e.g., paint or color correction projects 102) is created, the process tree indicating the flow of data through the nodes 102-104 is built automatically. As illustrated in FIG. 1, various source nodes in the form of clips 106-110 are utilized. As illustrated, front clip 106, back clip 108, and matte clip 110 may be utilized by color correction node 102. The color correction node 102 performs an operation (i.e., a color correction to the clips 106-110) on the clips 106-110 to produce a result/output 104.

As used herein, an operator (e.g., color correction operator 102) is the most common node. Alternative nodes may be used to connect two nodes. The process tree (such as the process tree illustrated in FIG. 1) can be used to manage operators and nodes. For example, users may add operators (e.g., a paint operation) to a branch, change the process order of operators 102-104, and navigate easily between operator controls. Further, if an operator is added to a layer in a schematic view 100, the operator will appear as a node (e.g., the color correct node 102). The same operator node may also appear in other workspace environments (e.g., a workspace panel). Further, in the schematic view, particular operators may be turned on/off as desired simply by clicking on the icon for that operator.

While the above prior art schematic view 100 and operations may be used to modify and edit an image/clip, the prior art has many limitations. For example, once the output clip 104 has been produced and rendered (and the process tree has been closed), prior art systems fail to store any of the node operations performed. Thus, the prior art does not permit a modification of the clip operations.

In addition, assuming multiple node operations are performed in a sequence on a clip, if a node operation performed earlier in the sequence is modified, subsequent node operations are invalidated/lost in the prior art. Each node operation is deemed to perform operations on the specific input provided. Thus, if the input no longer exists (e.g., has been changed or deleted), the node operation has no input and cannot perform the designated operation. Accordingly, prior art systems merely delete such nodes and all settings associated therewith. For example, if three operations are performed on a clip and the user later edits the first operation, the second and third operations will be invalid/lost. To perform such operations, the user must repeat and reconfigure such nodes/operations.

In view of the above, what is needed is flexibility with respect to viewing and working with clips.

### SUMMARY OF THE INVENTION

Prior art audio/video applications do not provide the ability to view and manipulate the operations used to create/produce a clip. In this regard, once a clip has been processed, the prior art does not retain information about operations used to obtain the clip.

One or more embodiments of the invention maintain a clip history for a clip. The clip history provides the ability to access and manipulate the operations used to create a clip. From each module, when processing is invoked, three pieces of information may be automatically recorded: (1) the name of the module used to create the clip; (2) the parameters in that module (including button settings, numeric parameters and animation curves); and (3) references to the input clips used in that stage of processing. If that output clip is then used as input to another module, when processing is invoked, it becomes referenced as an input clip in the clip history of that subsequent clip. In this way, a process tree may be automatically created for the user, representing all steps used to create each particular clip.

While the process tree is most naturally represented as a schematic view, it is not necessary for the user to view the tree in a schematic view in order to utilize clip history. The clip can also be used to invoke the module that was last used to edit the clip, allowing the user to view and change the most recent operation performed on that clip. For deeper modification, the clip may be expanded into a process tree of a procedural renderer. Once expanded, the user may view and edit the various clip operations. If a clip operation is modified, when processed, a new clip having a new clip history may be created/produced. Further, a user can modify an operation in a clip history without affecting or losing remaining clip operations (including those clip operations originally performed subsequent to the modified clip operation).

In addition, if multiple clip segments have been edited together with one clip segment having a clip history, the per segment history of the clip/clip segment may be viewed. The operations within the clip segment history may then be modified. Once modified, the user can opt to process the entire clip (thereby creating a new output clip) or the user can opt to process the modified clip segment only without rendering/processing the entire clip. Thus, the user may manipulate a single clip segment and the results of such segment manipulation without rendering an entire clip.

### BRIEF DESCRIPTION OF THE DRAWINGS

Referring now to the drawings in which like reference numbers represent corresponding parts throughout:

FIG. 1 illustrates a process tree in a schematic view;

FIG. 2 is an exemplary hardware and software environment used to implement one or more embodiments of the invention;

FIG. 3 illustrates detailed components of the hardware of FIG. 2 in accordance with one or more embodiments of the invention;

FIG. 4 illustrates the modification of a clip history using an editing module in accordance with one or more embodiments of the invention;

FIG. 5 illustrates the use of a process tree in a schematic view in accordance with one or more embodiments of the invention;

FIG. 6 illustrates the use of a timeline in accordance with one or more embodiments of the invention; and

FIG. 7 is a flow chart that illustrates the modifying/processing of a clip in accordance with one or more embodiments of the invention.

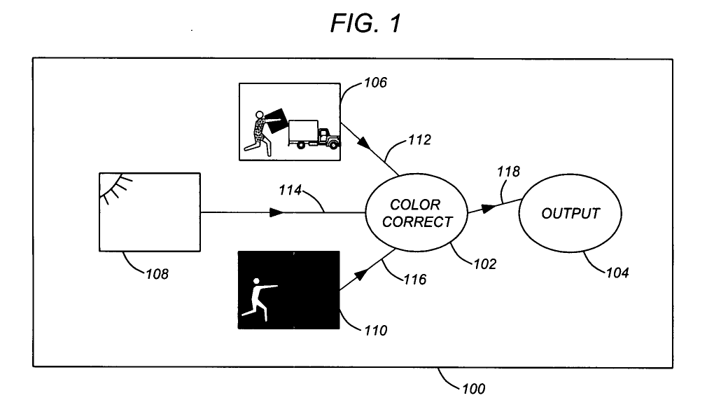

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Hardware Environment

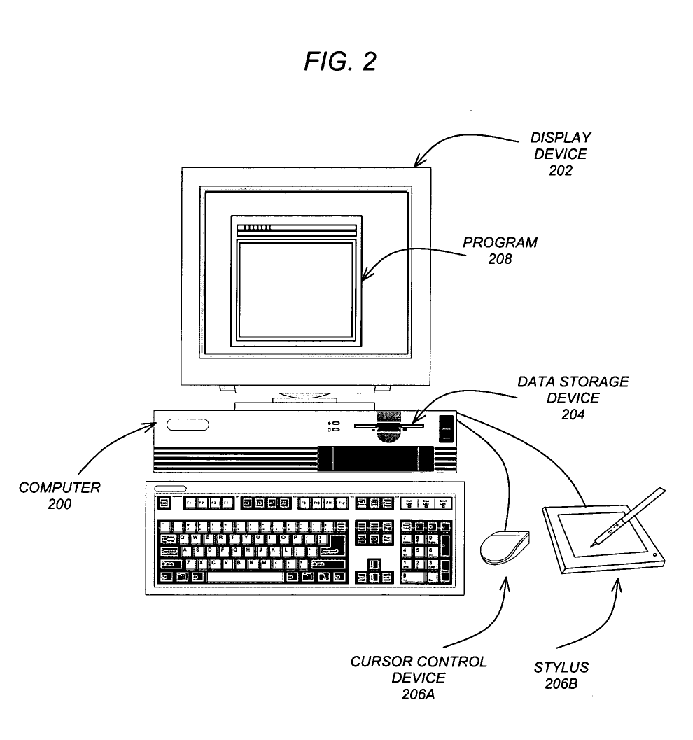

FIG. 2 is an exemplary hardware and software environment used to implement one or more embodiments of the invention. Embodiments of the invention are typically implemented using a computer 200, which generally includes, inter alia, a display device 202, data storage device(s) 204, cursor control devices 206A, stylus 206B, and other devices. Those skilled in the art will recognize that any combination of the above components, or any number of different components, peripherals, and other devices, may be used with the computer 200.

One or more embodiments of the invention are implemented by a computer-implemented program 208. Such a program may be a procedural renderer (i.e., an application that provides the ability to edit operators in a schematic view), a paint application, a media player, a video editing program, an effects program, compositing application, or any type of program that executes on a computer 200. The program 208 may be represented by a window displayed on the display device 202. Generally, the program 208 comprises logic and/or data embodied in or readable from a device, media, carrier, or signal, e.g., one or more fixed and/or removable data storage devices 204 connected directly or indirectly to the computer 200, one or more remote devices coupled to the computer 200 via a data communications device, etc. In addition, program 208 (or other programs described herein) may be an object-oriented program having objects and methods as understood in the art.

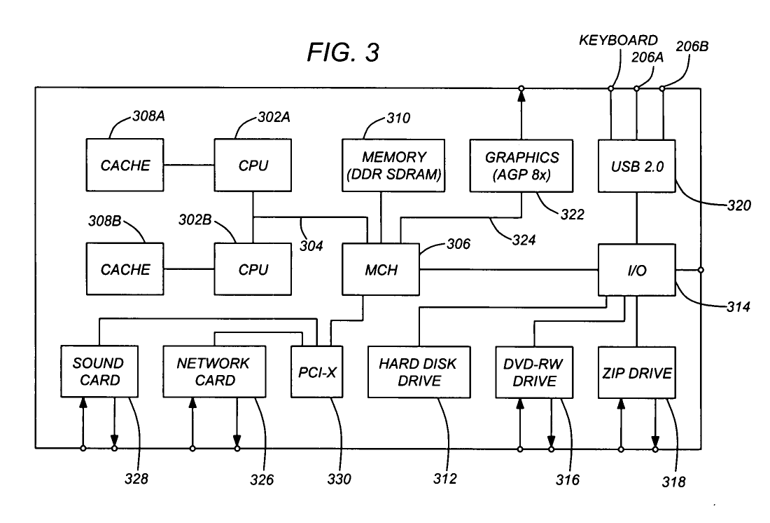

The components of computer system 200 are further detailed in FIG. 3 and, in the preferred embodiment of the present invention, said components are based upon the Intel® E7505 hub-based chipset.

The system 200 includes two Intel® Pentium™ Xeon™ DP central processing units (CPU) 302A, 302B running at three Gigahertz, that fetch and execute instructions and manipulate data via a system bus 304 providing connectivity with a Memory Controller Hub (MCH) 306. CPUs 302A, 302B are configured with respective high-speed caches 308A, 308B comprising at least five hundred and twelve kilobytes, which store frequently-accessed instructions and data to reduce fetching operations from a larger memory 310 via MCH 306. The MCH 306 thus co-ordinates data flow with a larger, dual-channel double-data rate main memory 310, that is between two and four gigabytes in data storage capacity and stores executable programs which, along with data, are received via said bus 304 from a hard disk drive 312 providing non-volatile bulk storage of instructions and data via an Input/Output Controller Hub (ICH) 314. The I/O hub 314 similarly provides connectivity to DVD-ROM read-writer 316 and ZIP™ drive 318, both of which read and write data and instructions from and to removable data storage media. Finally, I/O hub 314 provides connectivity to USB 2.0 input/output sockets 320, to which the stylus and tablet 306B combination, keyboard, and mouse 306A are connected, all of which send user input data to system 200.

A graphics card 322 receives graphics data from CPUs 302A, 302B along with graphics instructions via MCH 306. The graphics card 322 may be coupled to the MCH 306 through a direct port 324, such as the direct-attached advanced graphics port 8X (AGP 8X) promulgated by the Intel® Corporation, the bandwidth of which exceeds the bandwidth of bus 304. The graphics card 322 may also include substantial dedicated graphical processing capabilities, so that the CPUs 302A, 302B are not burdened with computationally intensive tasks for which they are not optimized.

Network card 326 provides connectivity to a framestore by processing a plurality of communication protocols, for instance a communication protocol suitable to encode and send and/or receive and decode packets of data over a Gigabit-Ethernet local area network. A sound card 328 is provided which receives sound data from the CPUs 302A, 302B along with sound processing instructions, in a manner similar to graphics card 322. The sound card 328 may also include substantial dedicated digital sound processing capabilities, so that the CPUs 302A, 302B are not burdened with computationally intensive tasks for which they are not optimized. Network card 326 and sound card 328 may exchange data with CPUs 302A, 302B over system bus 304 by means of Intel®'s PCI-X controller hub 330 administered by MCH 306.

Those skilled in the art will recognize that the exemplary environment illustrated in FIGS. 2 and 3 are not intended to limit the present invention. Indeed, those skilled in the art will recognize that other alternative environments may be used without departing from the scope of the present invention.

Software Environment

As described above, a software application 208 such as a video effects program or a procedural renderer (that permits the viewing of different operations schematically) may execute on computer 200. In embodiments of the invention, such software applications 208 provide for a clip history feature that remembers most operations performed on a clip or a clip segment. Such an ability to retain operations on a per clip/clip segment basis also enables the ability to preserve the operations of a node in a sequence when an earlier node in the sequence is modified.

To record the clip history, from each module, when processing is invoked, three pieces of information may be automatically recorded: (1) the name of the module used to create the clip; (2) the parameters in that module (including button settings, numeric parameters and animation curves); and (3) references to the input clips used in that stage of processing. If the output clip is then used as input to another module, when processing is invoked, it becomes referenced as an input clip in the clip history of that subsequent clip. In this way, a process tree is automatically created for the user, representing all steps used to create each particular clip.

While the process tree is most naturally represented as a schematic view, it is not necessary for the user to view the tree schematically in order to utilize the clip history. As described in more detail below, the clip can be used to invoke a particular module. Alternatively, the clip (and accompanying clip history) can be expanded into a process tree

Clips can be modified at any point in a history to create a new clip. In other words, once a particular node/operation that is part of a clip history is modified, a new clip with the modification is created. Such a new clip would then have its own clip history. There are three primary ways that a software application 208 can modify a clip using its clip history.

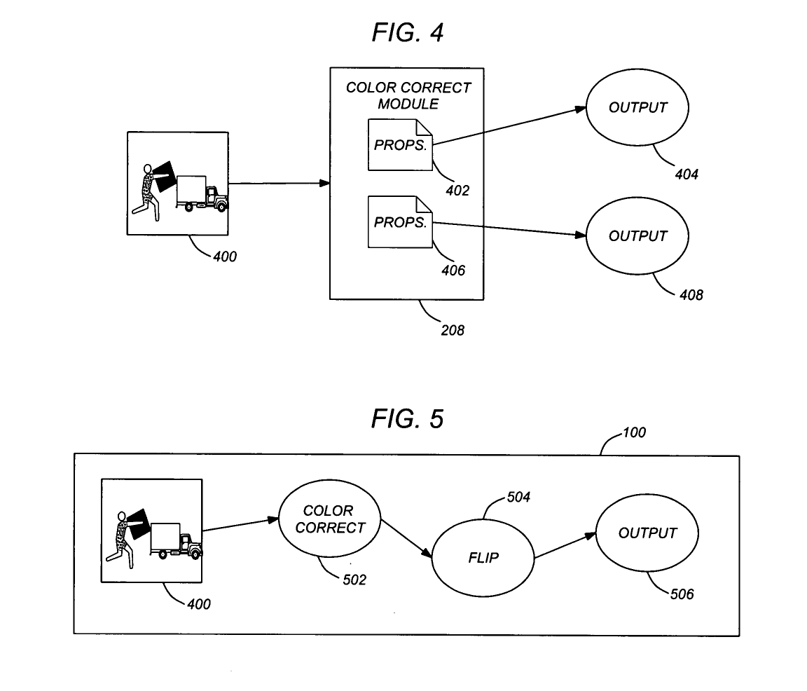

The simplest mechanism for using clip history is to load a processed clip back into the last module that was used to create the clip. FIG. 4 illustrates such an embodiment. A clip 400 may be loaded into an application 208 such as a color corrector module, the color/color properties 402 may be modified, and a new clip 404 is then processed/created/output. The user may then elect to change the color slightly again. To change the color, the user may double-click (e.g., using cursor control device 206A or stylus 206B) the new clip 404 to go back into the color corrector module/application 208 with the settings 402 restored. After the values are slightly modified/tweaked (to produce a new set of properties 406), another third clip 408 (with its own clip history) is created. As illustrated, the color correction module/application 208 is started and the different clips 400, 404, and 408 may be loaded into the module for editing.

As described above, the various operations performed on a clip may be viewed schematically in a procedural renderer. In a second method to modify a clip using a clip history, the various modifications are loaded into such a processing tree. FIG. 5 illustrates the use of a process tree in a schematic view 100 in accordance with one or more embodiments of the invention. When multiple modules 502-506 were used to create a clip, all of the nodes 502-506 can be loaded into a processing tree. Thereafter, the user can make modifications at any point in the schematic 100. For instance, the user may have created an output 605 by color correcting 502 a clip 400 and further modifying the clip (for example, with a flip 504). By loading the resulting clip 506 into the process tree, the clip can be modified at any point in the processing tree. Thereafter, a new clip 506 may be processed/created.

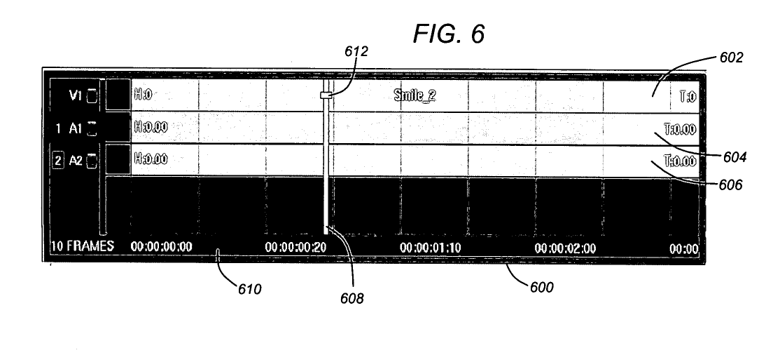

A third method utilizes a timeline within a parent application (e.g., a procedural renderer or software application 208) to modify a clip/clip segment. FIG. 6 illustrates the use of a timeline in accordance with one or more embodiments of the invention. The timeline 600 can be used to edit a single clip, or arrange a sequence of clips. Using the timeline 600, a user can perform editing operations such as splices, cuts, and dissolves without having to leave a procedural renderer application. The timeline environment enhances the editing process by providing precise tools that allow users to control the view of, and work with, all the video and audio elements of a sequence. Additionally, users have the ability to edit audio tracks separately from video, and edit individual audio tracks. The timeline 600 may be used with a variety of views of a parent application (e.g., a schematic view 100, a result view, and/or a context view).

Each clip loaded into a procedural renderer has an associated timeline. To build a clip sequence, clips may be copied from the schematic view 100 to a clip's timeline 600. However, the clips loaded into a particular timeline 600 may be required to comply with a particular resolution or range of resolutions. In addition, the timeline 600 can contain one video track and one or two audio tracks. In a timeline 600, the video segments, audio segments, and transitions that comprise the edit sequence are collectively referred to as elements. As illustrated in FIG. 6, timeline 600 has a single video track 602 and two (2) audio tracks 604-606. Positioner 608 indicates the current frame and may be moved to any point in the displayed area of the timeline 600 by clicking the scrub bar 610. The focus point 612 on the positioner 608 indicates the current track 602-606. Editing operations that are performed on a single track 602-606 are performed on the current track. As illustrated in FIG. 6, video track 602 is the current track as indicated by the focus point 612.

If multiple clips are edited together to create a clip with soft edits, and at least one of the clips had a clip history, the segment with the clip history may be modified in the timeline 600. With this method, the timeline 600 is accessed, the appropriate segment is selected, and the selected segment may then be expanded into a processing tree as illustrated in FIG. 5. Once in the schematic view 100, changes may be made to any node or clip. When outputting modified clips, the procedural renderer may provide the option to process the entire clip, or to process the modified segment only. Further, if a clip history having an Action module is expanded, only the Action layers that contain clips with history will be expanded. Layers without history are simply loaded as Action layers. As used herein, an Action module is a multilayer compositing tool for creating complex visual effects. For example, an Action module may be used to animate clips in 3D and add camera, lighting, shadow, and particle effects.

As described above, three primary methods may be used to modify a clip using a clip history. To enable the use of a clip history, a clip history option may be required to be enabled (e.g., in/through a system preferences dialog). When enabling a clip history, the user may have the option of keeping only the sources (e.g., clips without a history), keeping both sources and references to all intermediate clips, and/or not keeping any frames (i.e., if the intermediate or sources are deleted from the desktop, they will be unavailable for the clip history as well). The three primary uses of clip history are set forth in more detail below.

Modifying a Clip in its Last Module

As described above, FIG. 4 illustrates the use of a module 208 to modify a clip with a clip history. A clip 400 having a clip history is loaded back into the most recent module 208 that was used to process the clip 400. For instance, clip A 400 may be brought back into the Color Corrector 208, where its hue is adjusted. Once adjusted, the clip 400 may be processed (e.g., by activating a process option/button) to create a second clip—clip B 404. Clip B 404 also has clip history. The user may opt to double-click clip B 404 to load clip B 404 back into the Color Corrector 208. The Color Corrector 208 opens displaying clip A 400 and the corresponding adjustment to the hue value.

Further adjustments may be made to the color values thereby and when processed clip C 408 results, which in turn has its own clip history. If a clip is manipulated using multiple modules 208, and settings from a module other than the last one need to be modified, the clip may be loaded into a procedural renderer. Further, if clips have been spliced together, the effects may only be modified in a timeline.

Modifying Clip History in a Procedural Renderer

As described above, for some clips, the clip history must be modified using a procedural renderer as illustrated in FIGS. 5 and 6. For example, any clip that was created using more than one effect or operation may be required to be modified in a procedural renderer. To gain access to the original sources and effects settings, a clip 400 is expanded into a processing tree illustrated in schematic view 100.

Further, if clips were edited together, and at least one of the clips has uncommitted clip history, that clip's history may only be accessed through a timeline 600. The clip history for a segment may also be expanded into a processing tree (e.g., as displayed in FIG. 5).

Some nodes in a clip history tree may appear as blank nodes. These wildcard nodes represent an effect that was applied to a clip that does not have an equivalent defined node (e.g., Text). Such wildcard nodes may be named after the module used to create them. Wildcard nodes may be disconnected or connected, but their values cannot be modified. In this regard, such wildcard nodes contain frames rendered at their position in the process tree.

Because wildcard node frames are rendered, changes made upstream may not propagate downstream. Thus, if upstream changes are needed, the effect may need to be recreated. To recreate the effect, a user may be required to exit the procedural renderer and rebuild the effect in the module originally used to create it.

Modifying a Clip in a Procedural Renderer

As described above, a clip with a clip history may be loaded into a procedural renderer to display a process tree that recreates the clip 506 from its original sources 400, through all operations and effects 502-504, to its final output 506. Once loaded into the process tree, a user can modify the process tree at any point. Once a clip 400 has been modified, the clip may be processed to create new clips (e.g., output 404 and 408), which, in turn, also have their own history.

Modifying a Segment Effect in a Timeline

The history of a clip's segment may be edited from a timeline 600 within a procedural renderer. Using a segment editor (that may be part of a timeline 600 processing application), a segment history tree that is local to the selected segment and independent from remaining properties of the procedural renderer, may be edited. In such an embodiment, all branches and nodes may only affect a selected segment. Further, the segment editor (within a timeline 600 application) may resemble a standard schematic view (such as that displayed in FIG. 5) with two notable exceptions. No output nodes 404 and 408 are required and all edits and effects apply to the selected segment. In this regard, a segment icon may replace the Output node 404 and 408.

When an effect is selected in a timeline 600, the user can either apply another effect to it (e.g., using a segment editor), or the effect may be modified (e.g., in a processing tree or segment history tree).

Logical Flow

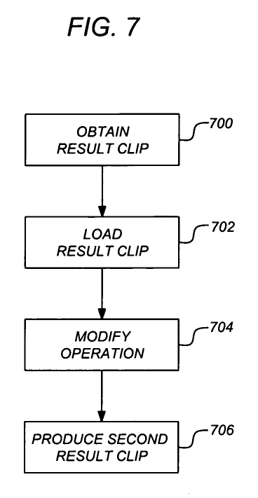

The above description sets forth the various features available in accordance with the invention. FIG. 7 sets forth the logical flow for implementing methods in accordance with one or more embodiments of the invention. Accordingly, FIG. 7 is a flow chart that illustrates the modifying/processing of a clip in accordance with one or more embodiments of the invention.

At step 700, a first processed result clip having a clip history is obtained. The clip history comprises at least one operation performed to produce the first result clip.

At step 702, the first result clip is loaded into a processing application. As described above, the processing application may comprise one of three different types of applications. One type of application is a module last used to produce the first result clip (e.g., a color corrector, compositer, etc.). A second type of application is a procedural renderer configured to display a process tree schematic view of a flow of image data of the first result clip. One or more nodes in the schematic view each represent an operation performed on the first result clip. The third type of application is a timeline or a timeline component of a procedural renderer wherein the timeline enables editing operations to be performed on multiple clip segments that have been edited together.

With the timeline based application, when the first result clip is loaded, a particular clip segment having a clip history may be selected and loaded into the process tree schematic view based application described above.

At step 704, the operation used to produce the first result clip is modified using the processing application. For example, the module last used to produce/create the clip may be used to modify a property setting. In the process tree schematic view based application, a node may be modified. In addition, the modification of the operation/node may not affect remaining nodes in the process tree. Thus, when node earlier in a sequence of nodes is modified, the performance of subsequent nodes is maintained as part of the clip history.

At step 706, a second result clip is produced based on the modified operation. Such a second result clip likely comprises a new clip having a new clip history comprising the modification. Further, in a timeline based application, the production of the second result clip may provide the user with the option of processing an entirely new second result clip or merely to process the selected clip segment containing the modified operation. Accordingly, a per segment history of a clip may be viewed and processed without rendering an entire clip.

### CONCLUSION

This concludes the description of the preferred embodiment of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method for modifying a clip comprising:
(a) obtaining a first processed result clip having a clip history, wherein the clip history comprises an operation performed to produce the first result clip;
(b) loading the first result clip into a processing application;
(c) modifying the operation using the processing application; and
(d) producing a second result clip based on the modified operation.

2. The method of claim 1, wherein the second result clip comprises a new clip having a new clip history.

3. The method of claim 1, wherein the modifying comprises modifying a property setting of the operation.

4. The method of claim 1, wherein the processing application comprises a module last used to produce the first result clip.

5. The method of claim 1, wherein:
the processing application comprises a procedural renderer configured to display a process tree schematic view of a flow of image data of the first result clip, wherein a node in the schematic view represents the operation performed on the first result clip; and
the modifying of the operation comprises modifying the node.

6. The method of claim 5, wherein:
the schematic view further comprises multiple nodes each representing an operation performed on the first result clip;
any node in the schematic view may be modified;
the method further comprises maintaining the clip history by maintaining nodes remaining in the process tree subsequent to the modifying of the operation.

7. The method of claim 1, wherein:
(a) the first result clip comprises multiple clip segments wherein at least one of the multiple clip segments has the clip history;
(b) the processing application comprises a procedural renderer having a timeline component, wherein the timeline component enables editing operations to be performed on the multiple clip segments; and
(c) the loading comprises:
(i) loading the first result clip into the timeline component;
(ii) selecting, in the timeline component, the clip segment having the clip history; and
(iv) loading the selected clip segment into a processing tree component of the procedural renderer, wherein the processing tree component displays a schematic view of a flow of clip image data, wherein a node in the schematic view represents the operation performed on the clip.

8. The method of claim 7, wherein the producing of the second result clip comprises providing an option to process all of the multiple clip segments to produce the second result clip or processing only the selected clip segment having the modified operation to produce the second result clip.

9. A computer implemented system for modifying a clip comprising:
(a) a computer having a memory;
(b) a processing application executing on the computer, wherein the processing application is configured to:
(i) load a first processed result clip having a clip history, wherein the clip history comprises an operation performed to produce the first result clip;
(ii) modify the operation using the processing application; and
(iii) produce a second result clip based on the modified operation.

10. The system of claim 9, wherein the second result clip comprises a new clip having a new clip history.

11. The system of claim 9, wherein the processing application is configured to modify the operation by modifying a property setting of the operation.

12. The system of claim 9, wherein the processing application comprises a module last used to produce the first result clip.

13. The system of claim 9, wherein:
the processing application comprises a procedural renderer configured to display a process tree schematic view of a flow of image data of the first result clip, wherein a node in the schematic view represents the operation performed on the first result clip; and
the processing application is configured to modify the operation by modifying the node.

14. The system of claim 13, wherein:
the schematic view further comprises multiple nodes each representing an operation performed on the first result clip;
any node in the schematic view may be modified; and
the system further comprises maintaining the clip history by maintaining nodes remaining in the process tree subsequent to the modifying of the operation.

15. The system of claim 9, wherein:
(a) the first result clip comprises multiple clip segments wherein at least one of the multiple clip segments has the clip history;
(b) the processing application comprises a procedural renderer having a timeline component, wherein the timeline component enables editing operations to be performed on the multiple clip segments; and
(c) the processing application is configured to load the first result clip by:
(i) loading the first result clip into the timeline component;
(ii) selecting, in the timeline component, the clip segment having the clip history; and
(iv) loading the selected clip segment into a processing tree component of the procedural renderer, wherein the processing tree component displays a schematic view of a flow of clip image data, wherein a node in the schematic view represents the operation performed on the clip.

16. The system of claim 15, wherein the processing application is configured to produce the second result clip by providing an option to process all of the multiple clip segments to produce the second result clip or to process only the selected clip segment having the modified operation to produce the second result clip.

17. A program storage device, readable by a computer, tangibly embodying at least one program of instructions executable by the computer to perform method steps of modifying a clip, the method steps comprising the steps of:
(a) obtaining a first processed result clip having a clip history, wherein the clip history comprises an operation performed to produce the first result clip;
(b) loading the first result clip into a processing application;
(c) modifying the operation using the processing application; and
(d) producing a second result clip based on the modified operation.

18. The program storage device of claim 17, wherein the second result clip comprises a new clip having a new clip history.

19. The program storage device of claim 17, wherein the modifying comprises modifying a property setting of the operation.

20. The program storage device of claim 17, wherein the processing application comprises a module last used to produce the first result clip.

21. The program storage device of claim 17, wherein:
the processing application comprises a procedural renderer configured to display a process tree schematic view of a flow of image data of the first result clip, wherein a node in the schematic view represents the operation performed on the first result clip; and
the modifying of the operation comprises modifying the node.

22. The program storage device of claim 21, wherein:
the schematic view further comprises multiple nodes each representing an operation performed on the first result clip;
any node in the schematic view may be modified;
The program storage device further comprises maintaining the clip history by maintaining nodes remaining in the process tree subsequent to the modifying of the operation.

23. The program storage device of claim 17, wherein:
(a) the first result clip comprises multiple clip segments wherein at least one of the multiple clip segments has the clip history;
(b) the processing application comprises a procedural renderer having a timeline component, wherein the timeline component enables editing operations to be performed on the multiple clip segments; and
(c) the loading comprises:
(i) loading the first result clip into the timeline component;
(ii) selecting, in the timeline component, the clip segment having the clip history; and
(iv) loading the selected clip segment into a processing tree component of the procedural renderer, wherein the processing tree component displays a schematic view of a flow of clip image data, wherein a node in the schematic view represents the operation performed on the clip.

24. The program storage device of claim 23, wherein the producing of the second result clip comprises providing an option to process all of the multiple clip segments to produce the second result clip or processing only the selected clip segment having the modified operation to produce the second result clip.
